(19) United States
(12) Patent Application Publication
(10) Pub. No.: US 2005/0193283 A1
(43) Pub. Date: Sep. 1, 2005

(54) Buffering unchecked stores for fault detection in redundant multithreading systems using speculative memory support

(76) Inventors: Steven K. Reinhardt, Vancouver, WA (US); Shubhendu S. Mukherjee, Framingham, MA (US); Joel S. Emer, Acton, MA (US); Christopher T. Weaver, Marlboro, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,618

(22) Filed: Dec. 30, 2003

(51) Int. Cl. G06F 11/00

(52) U.S. Cl. 714/48

(57) ABSTRACT

A multithreaded architecture is disclosed for buffering unchecked stores for fault detection in redundant multithreading systems using speculative memory support. In particular, the performance of a SRT processor is enhanced by using speculative memory support to buffer the leading threads stores until they can be compared with their trailing thread counterparts. Buffering these stores in the memory system allows them to be removed from the store buffer. Since the speculative memory system will have greater capacity than the store buffer, additional stores may be buffered before the leading thread will be forced to stall. This will result in an increase in slack between threads, and thus an increase in performance.

### RELATED APPLICATION

This U.S. Patent application is related to the following U.S. Patent application:
(1) MANAGING EXTERNAL MEMORY UPDATE FOR FAULT DETECTION IN RMS USING SPECULATIVE MEMORY SUPPORT, application number (Attorney Docket No. P17403), filed Dec. 30, 2003.

### BACKGROUND INFORMATION

Processors are becoming increasingly vulnerable to transient faults caused by alpha particle and cosmic ray strikes. These faults may lead to operational errors referred to as “soft” errors because these errors do not result in permanent malfunction of the processor. Strikes by cosmic ray particles, such as neutrons, are particularly critical because of the absence of practical protection for the processor. Transient faults currently account for over 90% of faults in processor-based devices.

As transistors shrink in size the individual transistors become less vulnerable to cosmic ray strikes. However, decreasing voltage levels the accompany the decreasing transistor size and the corresponding increase in transistor count for the processor results in an exponential increase in overall processor susceptibility to cosmic ray strikes or other causes of soft errors. To compound the problem, achieving a selected failure rate for a multi-processor system requires an even lower failure rate for the individual processors. As a result of these trends, fault detection and recovery techniques, typically reserved for mission-critical applications, are becoming increasing applicable to other processor applications.

Silent Data Corruption (SDC) occurs when errors are not detected and may result in corrupted data values that can persist until the processor is reset. The SDC Rate is the rate at which SDC events occur. Soft errors are errors that are detected, for example, by using parity checking, but cannot be corrected.

Fault detection support can reduce a processor's SDC rate by halting computation before faults can propagate to permanent storage. Parity, for example, is a well-known fault detection mechanism that avoids silent data corruption for single-bit errors in memory structures. Unfortunately, adding parity to latches or logic in high-performance processors can adversely affect the cycle time and overall performance. Consequently, processor designers have resorted to redundant execution mechanisms to detect faults in processors.

Current redundant-execution systems commonly employ a technique known as “lockstepping” that detects processor faults by running identical copies of the same program on two identical lockstepped (cycle-synchronized) processors. In each cycle, both processors are fed identical inputs and a checker circuit compares the outputs. On an output mismatch, the checker flags an error and can initiate a recovery sequence. Lockstepping can reduce processors SDC FIT by detecting each fault that manifests at the checker. Unfortunately, lockstepping wastes processor resources that could otherwise be used to improve performance.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 is a block diagram of one embodiment of a redundantly multithreaded architecture with the redundant threads.

FIG. 2 is a block diagram of one embodiment of a simultaneous and redundantly threaded architecture.

FIG. 3 illustrates minimum and maximum slack relationships for one embodiment of a simultaneous and redundantly multithreaded architecture.

FIG. 4 is a flow diagram of memory system extensions to manage inter-epoch memory data dependencies.

FIG. 5 is a block diagram of one embodiment of a speculative memory system buffering unchecked stores in a redundant multithreading architecture.

FIG. 6 is a flow diagram of speculative memory system buffering unchecked stores in redundant multithreading architecture.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

Sphere of Replication

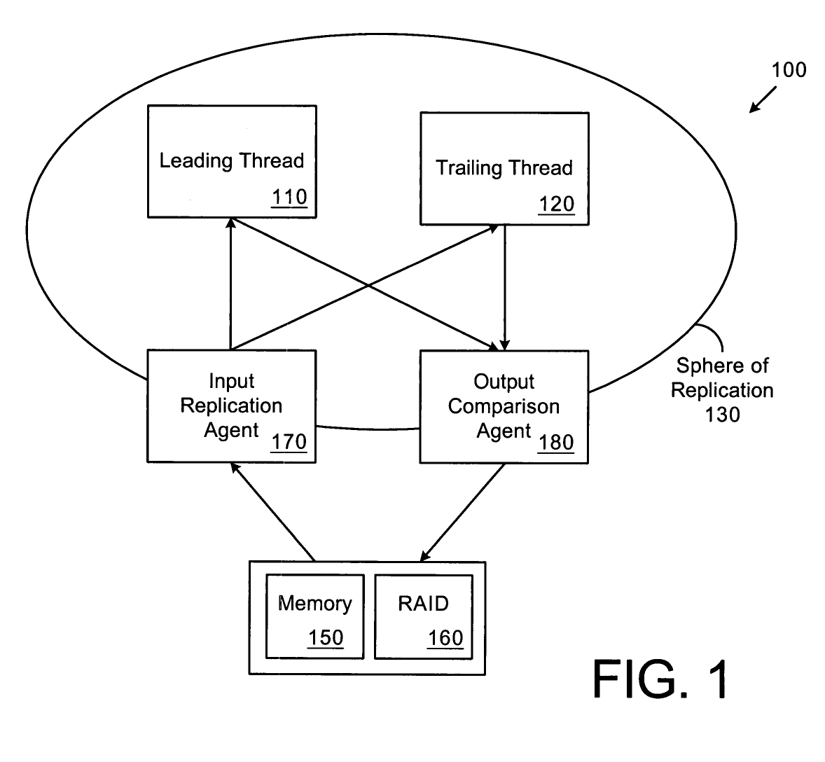

FIG. 1 is a block diagram of one embodiment of a redundantly multithreaded architecture. In a redundantly multithreaded architecture faults can be detected by executing two copies of a program as separate threads. Each thread is provided with identical inputs and the outputs are compared to determined whether an error has occurred. Redundant multithreading can be described with respect to a concept referred to herein as the “sphere of replication.” The sphere of replication is the boundary of logically or physically redundant operation.

Components within sphere of replication 130 (e.g., a processor executing leading thread 110 and a processor executing trailing thread 120) are subject to redundant execution. In contrast, components outside sphere of replication 130 (e.g., memory 150, RAID 160) are not subject to redundant execution. Fault protection is provide by other techniques, for example, error correcting code for memory 150 and parity for RAID 160. Other devices can be outside of sphere of replication 130 and/or other techniques can be used to provide fault protection for devices outside of sphere of replication 130.

Data entering sphere of replication 130 enter through input replication agent 170 that replicates the data and sends a copy of the data to leading thread 110 and to trailing thread 120. Similarly, data exiting sphere of replication 130 exit through output comparison agent 180 that compares the data and determines whether an error has occurred. Varying the boundary of sphere of replication 130 results in a performance versus amount of hardware tradeoff. For example, replicating memory 150 would allow faster access to memory by avoiding output comparison of store instructions, but would increase system cost by doubling the amount of memory in the system.

In general, there are two spheres of replication, which can be referred to as “SoR-register” and “SoR-cache.” In the SoR-register architecture, the register file and caches are outside the sphere of replication. Outputs from the SoR-register sphere of replication include register writes and store address and data, which are compared for faults. In the SoR-cache architecture, the instruction and data caches are outside the sphere of replication, so all store addresses and data, but not register writes, are compared for faults.

The SoR-cache architecture has the advantage that only stores (and possibly a limited number of other selected instructions) are compared for faults, which reduces checker bandwidth and improves performance by not delaying the store operations. In contrast, the SoR-register architecture requires comparing most instructions for faults, which requires greater checker bandwidth and can delay store operations until the checker determines that all instructions prior to the store operation are fault-free. The SoR-cache can provide the same level of transient fault coverage as SoR-register because faults that do not manifest as errors at the boundary of the sphere of replication do not corrupt the system state, and therefore, are effectively masked.

In order to provide fault recovery, each instruction result should be compared to provide a checkpoint corresponding to every instruction. Accordingly, the SoR-register architecture is described in greater detail herein.

Overview of Simultaneous and Redundantly Threaded (SRT) Architecture

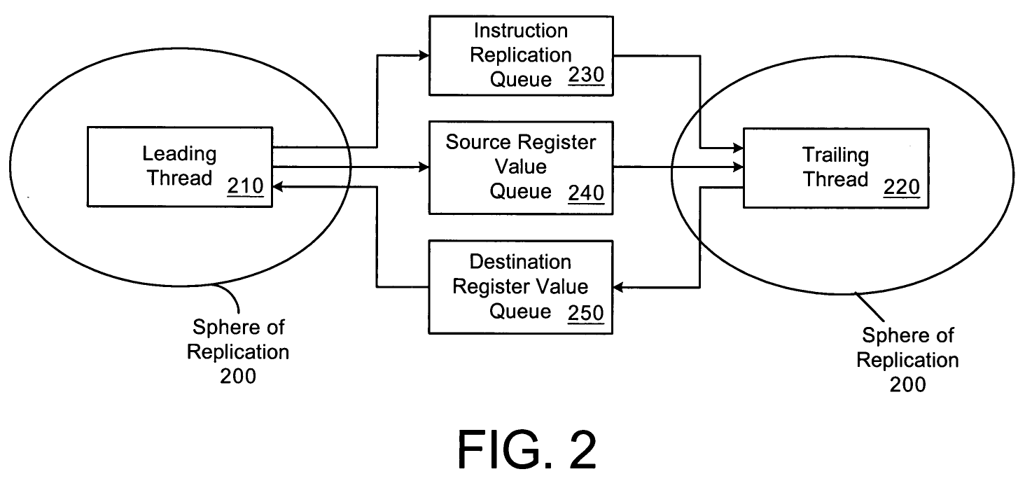

FIG. 2 is a block diagram of one embodiment of a simultaneous and redundantly threaded architecture. The architecture of FIG. 2 is a SoR-register architecture in which the output, or result, from each instruction is compared to detect errors.

Leading thread 210 and trailing thread 220 represent corresponding threads that are executed with a time differential so that leading thread 210 executes instructions before trailing thread 220 executes the same instruction. In one embodiment, leading thread 210 and trailing thread 220 are identical. Alternatively, leading thread 210 and/or trailing thread 220 can include control or other information that is not included in the counterpart thread. Leading thread 210 and trailing thread 220 can be executed by the same processor or leading thread 210 and trailing thread 220 can be executed by different processors.

Instruction addresses are passed from leading thread 210 to trailing thread 220 via instruction replication queue 230. Passing the instructions through instruction replication queue 230 allows control over the time differential or “slack” between execution of an instruction in leading thread 210 and execution of the same instruction in trailing thread 220.

Input data are passed from leading thread 210 to trailing thread 220 through source register value queue 240. In one embodiment, source register value queue 240 replicates input data for both leading thread 210 and trailing thread 220. Output data are passed from trailing thread 220 to leading thread 210 through destination register value queue 250. In one embodiment, destination register value queue 240 compares output data from both leading thread 210 and trailing thread 220.

In one embodiment, leading thread 210 runs hundreds of instructions ahead of trailing thread 220. Any number of instructions of “slack” can be used. In one embodiment, the slack is caused by slowing and/or delaying the instruction fetch of trailing thread 220. In an alternate embodiment, the slack can be caused by instruction replication queue 230 or an instruction replication mechanism, if instruction replication is not performed by instruction replication queue 230.

Further details for techniques for causing slack in a simultaneous and redundantly threaded architecture can be found in “Detailed Design and Evaluation of Redundant Multithreading Alternatives,” by Shubhendu S. Mukherjee, Michael Kontz and Steven K. Reinhardt in Proc. 29^{th} Int'l Symp. on Computer Architecture, May 2002 and in “Transient Fault Detection via Simultaneous Multithreading,” by Steven K. Reinhardt and Shubhendu S. Mukherjee, in Proc. 27^{th} Int'l Symp. on Computer Architecture, June 2000.

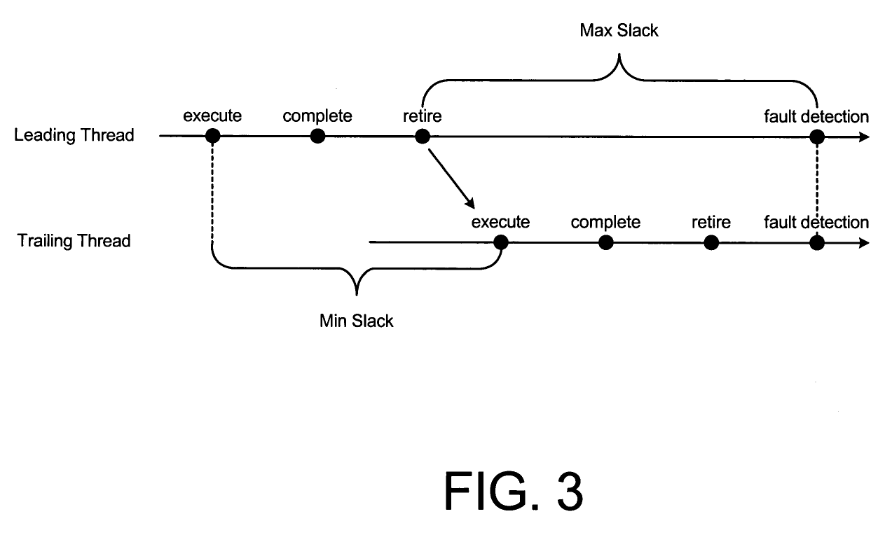

FIG. 3 illustrates minimum and maximum slack relationships for one embodiment of a simultaneous and redundantly threaded architecture. The embodiment of FIG. 3 is a SoR-register architecture as described above. The minimum slack is the total latency of a cache miss, latency from execute to retire, and latency incurred to forward the load address and value to the trailing thread. If the leading thread suffers a cache miss and the corresponding load from the trailing thread arrives at the execution point before the minimum slack, the trailing thread is stalled.

Similarly, the maximum slack is latency from retire to fault detection in the leading thread. In general, there is a certain amount of buffering to allow retired instructions from the leading thread to remain in the processor after retirement. This defines the maximum slack between the leading and trailing threads. If the buffer fills, the leading thread is stalled to allow the trailing thread to consume additional instructions from the buffer. Thus, if the slack between the two threads is greater than the maximum slack, the overall performance is degraded.

Speculative Memory Support

In a speculative multithreading system, a sequential program is divided into logically sequential segments, referred to as epochs or tasks. Multiple epochs are executed in parallel, either on separate processor cores or as separate threads within an SMT processor. At any given point in time, only the oldest epoch corresponds to the execution of the original sequential program. The execution of all other epochs is based on speculating past potential control and data hazards. In the case of an inter-epoch misspeculation, the misspeculated epochs are squashed. If an epoch completes execution and becomes the oldest epoch, its results are committed to the sequential architectural state of the computation.

In one embodiment of a speculative multithreading system, the compiler may partition the code statically into epochs based on heuristics. For example, loop bodies may often be used to form epochs. In this case, multiple iterations of the loop would create multiple epochs at runtime that would be executed in parallel.

The system must enforce inter-epoch data hazards to maintain the sequential program's semantics across this parallel execution. In one embodiment, the compiler is responsible for epoch formation, so it can manage register-based inter-epoch communication explicitly (perhaps with hardware support). Memory-based data hazards are not (in general) statically predictable, and thus must be handled at runtime. Memory-system extensions to manage inter-epoch memory data dependences, satisfying them when possible, and detecting violations and squashing epochs otherwise, are a key component of any speculative multithreading system.

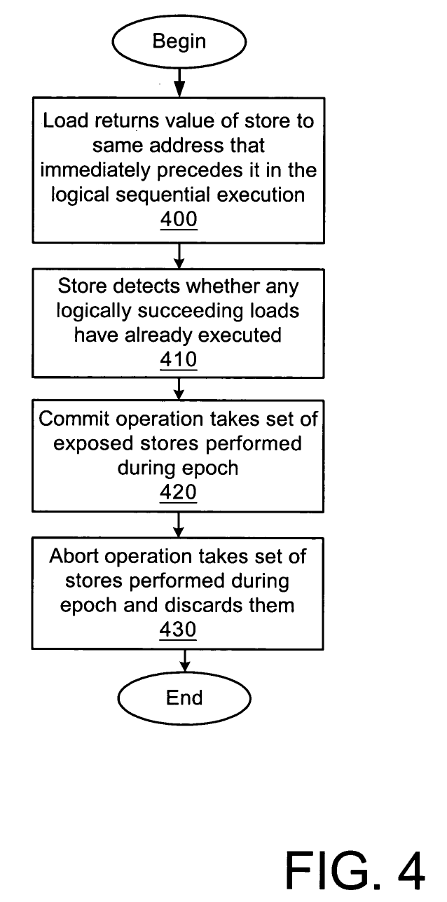

FIG. 4 illustrates memory system extensions to manage inter-epoch memory data dependences. Detecting violations and squashing epochs are an important feature of any speculative multithreading system. In one embodiment, a load must return the value of a store to the same address that immediately precedes it in a program's logical sequential execution, step 400. For example, the system must return in priority order the following. First, the value from the most recent prior store within the same epoch, if any. Second, the value from the latest store in the closest logically preceding epoch, if any. Finally, the value from the committed sequential memory state. Furthermore, the load must not be affected by any logically succeeding stores that have already been executed. This is assuming that the processor guarantees that memory references appear to execute sequentially within an epoch, so therefore, any logically succeeding stores will belong to logically succeeding epochs.

Next, a store must detect whether any logically succeeding loads have already executed, 410. If they have, they are violating the data dependence. Any epoch containing such a load, and potentially any later epoch as well, must then be squashed. A commit operation takes the set of exposed stores performed during an epoch and applies them atomically to the committed sequential memory state, 420. An exposed store is the last store to a particular location within an epoch. Non-exposed stores, i.e., those whose values are overwritten within the same epoch, are not observable outside of the epoch in which they execute. Finally, an abort operation takes the set of stores performed during an epoch and discards them, 430.

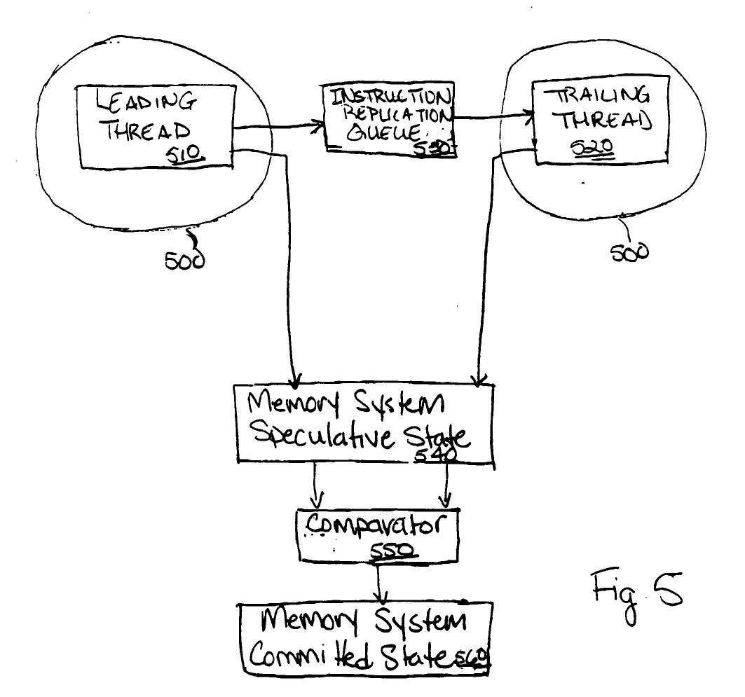

FIG. 5 is a block diagram of a one embodiment of a speculative memory support buffering unchecked stores in a redundant multithreading architecture. Leading thread 510 and trailing thread 520 execute epochs in parallel. An instruction replication queue 530 sends the epoch from the leading thread 510 to the trailing thread 520. Both the leading thread 510 and the trailing thread 520 have a sphere of replication 500.

Individual executions of a particular epoch is known as an epoch “instance”. The two instances of epoch are executed in parallel by the leading thread 510 and the trailing thread 520 of the RMT system. Once executed, the stores are sent to a memory system 540. The stores are kept in the memory system as speculative stores, using the speculative memory support described above. Once both instances of the epoch have completed, the exposed stores are compared 550. If the compared stores match, a single set of exposed stores is committed to the architectural memory state 560.

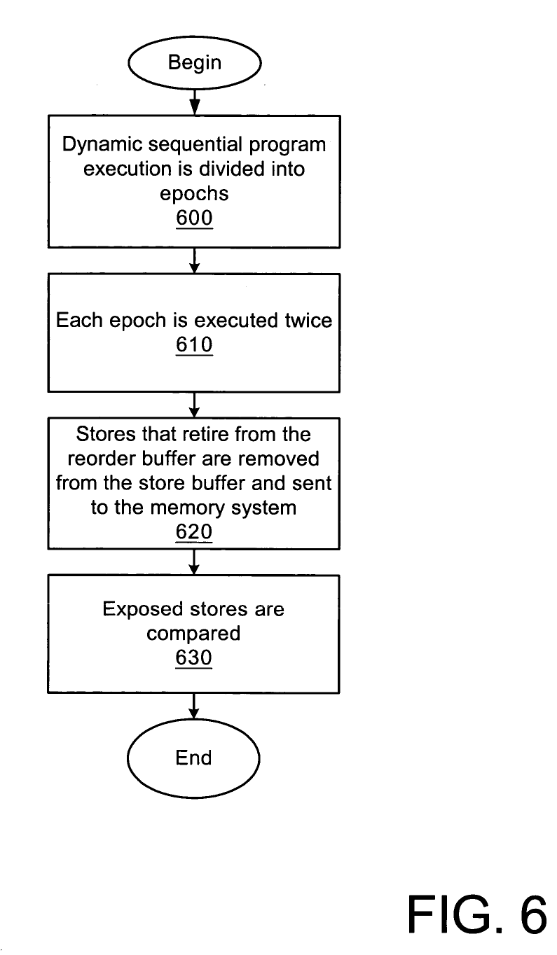

FIG. 6 illustrates speculative memory support that may be applied to buffering of unchecked stores in redundant multithreading architecture. In one embodiment, the dynamic sequential program execution is divided into epochs, as in speculative multithreading, 600. Ideally, to maintain backward compatibility, compiler support would not be required. Then, each epoch is executed twice, 610. The two instances of an epoch are executed in parallel by the leading and trailing threads of the RMT system. Unlike previously proposed RMT implementations, stores are not kept in the store buffer to await checking. Instead, stores that retire from the reorder buffer (i.e., commit in the out-of-order execution sense) are removed from the store buffer and sent to the memory system, but are kept as speculative stores (using the speculative memory support described above), 620. Finally, after both instances of an epoch have completed, the exposed stores are compared, 630. If the results match, then a single set of exposed stores is committed to the architectural memory state.

Because unchecked stores are buffered in the memory system and not in the store buffer, the total capacity available for buffering these stores is greatly increased. (Unlike the store buffer, which is typically limited to tens of entries by cycle time constraints, the buffering available in speculative memory systems often corresponds to the capacity of the L1 cache, i.e., several kilobytes.) As a result of this greater capacity, the maximum amount of achievable slack between the leading and trailing threads increases, enabling higher performance. The potential for deadlock between the leading and trailing threads is also reduced.

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

1. A method comprising:
executing corresponding instruction threads in parallel as a leading thread and a trailing thread;
saving result from the instruction executed in the leading thread and result from the instruction executed in the trailing thread to memory;
comparing the results saved in memory; and
committing a single set of instruction to a memory state based on the compared result.

2. The method of claim 1, wherein the saved result are saved as speculative.

3. The method of claim 2, wherein the executed instructions are buffered in the memory.

4. The method of claim 1 wherein the instructions are epoch instructions.

5. An apparatus comprising:
means for executing parallel threads as a leading thread and a trailing thread;
means for saving the executed threads in a memory;
means for comparing the results saved in memory; and
means for committing a single set of thread to a memory state based on the compared result.

6. The apparatus of claim 5 wherein the executed threads are epoch threads.

7. The apparatus of claim 6, wherein each epoch is executed twice.

8. The apparatus of claim 5 wherein the executed threads are buffered.

9. The apparatus of claim 8 wherein the buffered threads are stored as speculative.

10. The apparatus of claim 9 wherein the single set is committed if the compare result matches.
